(19) United States
(12) Patent Application Publication
(10) Pub. No.: US 2006/0052194 A1
(43) Pub. Date: Mar. 9, 2006

(54) Torsional force linear tensioner

(76) Inventor: Douglas G. Gerring, Republic, MO (US)

Correspondence Address: DAYCO PRODUCTS, LLC, 1 PRESTIGE PLACE, MIAMISBURG, OH, 45342, US

(21) Appl. No.: 10/934,196

(22) Filed: Sep. 3, 2004

(51) Int. Cl. F16H 7/08; F16H 7/22

(52) U.S. Cl. 474/109; 474/101

(57) ABSTRACT

A linear tensioner driven by a torque input is provided having a base, a pinion rotatably mounted on the base, a rack operatively engaged with the pinion, an arm slideably mounted on the base and coupled to the rack for linear movement therewith, and a pulley rotatably mounted on the arm to engage and tension an associated power transmitting element such as a belt or chain. The tensioner further includes a means for applying a rotational force to the pinion, which may be, for example, a torsion spring, a servo motor or a hydraulic pump.

### TECHNICAL FIELD

The present invention relates generally to tensioners, and more particularly, to linearly acting tensioners driven by a torque input.

### BACKGROUND

Linearly acting tensioners for tensioning power-transmitting belts and chains are known. In contrast to rotary or pivoting tensioner designs, the tensioning arm of a linear tensioner follows a straight path. As a result, linearly acting tensioners may provide greater belt slack take-up per distance of arm travel than rotary tensioner designs and may further provide packaging advantages.

Current linear tensioner designs are not ideal. In particular, current designs, which typically utilize linear compression or extension springs that are either co-linear or parallel to the tensioning arm, require cumbersome tools and adjustments during and after installation to ensure optimal working range and tension of the power transmitting element. Moreover, the use of linear springs to provide a tensioning force limits the useful travel range of the tensioner arm, limits the functional spring rate, and may result in excessive torque decay. Accordingly, a new linearly acting tensioner design is desired. More specifically, a new linear tensioner design is desired that can provide a tensioning force through applied torque. Another objective is to provide such a tensioner that can fit within similar packaging constraints as existing tensioners.

### SUMMARY

According to a first aspect, a tensioner for tensioning a power transmitting element is provided, the tensioner having a rotatable element and a translating element operatively engaged with the rotatable element. Rotation of the rotatable element in a first rotational direction causes translation of the translating element in a first linear direction to tension the power transmitting element. Conversely, translation of the translating element in a second linear direction causes the rotatable element to rotate in a second rotational direction. The tensioner according to this embodiment may further include a rotary actuator for applying a rotational force to the rotatable element and a pulley that is rotatably coupled to the translating element for engaging and tensioning the associated power transmitting element.

According to a second aspect, a tensioner for tensioning a power transmitting element is provided, the tensioner having a rotatable element and a translating element operatively engaged with the rotatable element so that rotation of the rotatable element in a first rotational direction causes translation of the translating element in a first linear direction. In addition, the translating element is capable of translating in a second linear direction opposite the first linear direction in response to force exerted by the associated power transmitting element.

According to a third aspect, a tensioner for tensioning a power transmitting element is provided, the tensioner having a rotatable element and a translating element operatively engaged with the rotatable element so that rotation of the rotatable element causes translation of the translating element. The tensioner according to this aspect is operable in a first condition and a second condition. In the first condition the rotatable element rotates in a first rotational direction and the translating element translates in a first linear direction. In the second condition the translating element translates in a second linear direction opposite the first linear direction and the rotatable element rotates in a second rotational direction. The tensioner according to this aspect may further include a rotary actuator for biasing the rotatable element to rotate in the first rotational direction and optionally for resisting rotation of the rotatable element in the second rotational direction.

According to one embodiment, a tensioner is provided having a base, a pinion rotatably mounted on the base, a rack operatively engaged with the pinion, an arm slideably mounted on the base and coupled to the rack for linear movement therewith, and a pulley rotatably mounted on the arm to engage and tension an associated power transmitting element such as a belt or chain. The tensioner, according to this embodiment, further includes a means for applying a rotational force to the pinion, which may be, for example, a torsion spring, a servo motor or a hydraulic pump. As used herein, “torsion spring” refers to any spring that provides a torsional return including, for example, a radially wound or spiral spring, an axially wound or helical spring, two opposing compression or extension springs that are oriented to provide a force couple, or a beam in torsion.

According to another embodiment, the tensioner may further include an intermediate gear rotatably mounted on the base and operatively engaged with both the rack and the pinion. The intermediate gear pitch diameter may be selected to provide additional linear travel for the tensioner arm, increased torque output, or desirable tensioner spring rate.

According to a third embodiment, the tensioner may further include a planetary gear set to couple the pinion to the means for applying a rotational force to the pinion. The planetary gear set may include a sun gear, a ring gear that is concentric with the sun gear, at least one planetary gear that is engaged with both the sun gear and the ring gear and a planetary gear arm that couples the pinion to the at least one planetary gear for movement therewith.

According to a fourth embodiment, the tensioner may further include a second rack operatively engaged with the pinion, a second arm slideably mounted on the base and coupled to the second rack for linear movement therewith and a second pulley rotatably mounted on the second arm to engage and tension an associated power transmitting element. In this configuration, the tensioner can be used to tension two belt spans simultaneously.

According to a fifth embodiment, a tensioner is provided having a base, a friction wheel rotatably mounted on the base, a rotary actuator for applying a rotational force to the friction wheel, an arm slideably mounted on the base, and a pulley rotatably coupled to the arm for movement therewith. The arm and the friction wheel are frictionally engaged so that rotation of the friction wheel will cause the arm to translate.

According to a sixth embodiment a tensioner is provided having a base, a spool rotatably mounted on the base, a rotary actuator for applying a rotational force to the spool, an arm slideably mounted on the base, and a pulley rotatably coupled to the arm for movement therewith. The tensioner according to this embodiment further includes a cable coupled at a first end to the arm and coupled at a second end to the spool. As the spool is rotated, the cable may be wound around the spool, thereby converting rotation of the spool into linear translation of the arm.

### BRIEF DESCRIPTION OF THE DRAWINGS

FIG. 1 is an isometric view of a tensioner according to one embodiment tensioning a power transmitting belt of a front end accessory drive;

FIG. 2 is a partially cut-away front view of a tensioner according to one embodiment;

FIG. 3 is an exploded view of the tensioner of FIG. 2;

FIG. 4a is an exploded view of a tensioner according to a second embodiment utilizing a servo motor as a rotary actuator;

FIG. 4b is an exploded view of a tensioner according to a second embodiment utilizing a hydraulic pump as a rotary actuator;

FIG. 5 is a partially cut-away front view of a tensioner according to a third embodiment;

FIG. 6 is a cross-section view of the tensioner of FIG. 5 along line A-A;

FIG. 7 is a partially cut-away top view a planetary gear train for a tensioner according to a fourth embodiment;

FIG. 8 is a cross-section view of the planetary gear train and tensioner of FIG. 7 along line B-B;

FIG. 9 is a partially cut-away front view of a tensioner according to a fifth embodiment;

FIG. 10 is a cross-section view of the tensioner of FIG. 9 along line C-C;

FIG. 11 is an exploded view of a tensioner according to another embodiment having a friction wheel; and

FIG. 12 is an exploded view of a tensioner according to yet another embodiment having a spool and cable.

### DETAILED DESCRIPTION

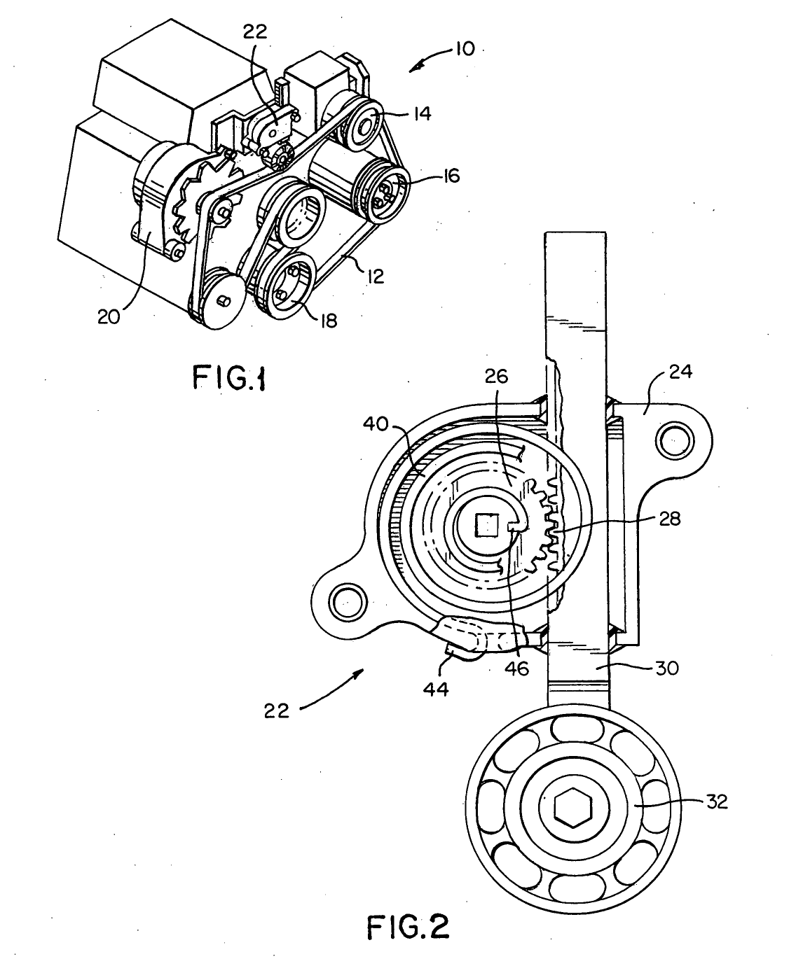

FIG. 1 depicts a typical front end accessory drive system 10 using a belt 12 to transmit power from a crankshaft 14 to a plurality of accessories 16, 18, 20, which may include for example an integrated starter/generator unit, a power steering unit or a compressor. A linear tensioner 22 according to one embodiment of the present invention is provided to take up slack in the belt 12 and prevent belt slip.

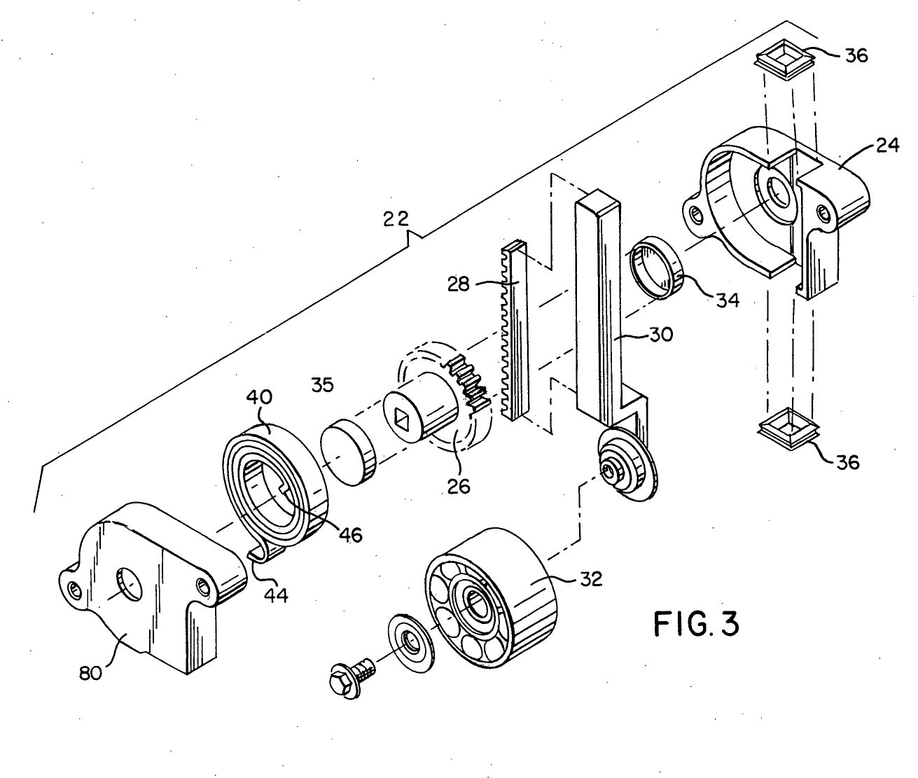

Referring now to FIGS. 2 and 3, the tensioner 22 according to a first embodiment includes a base or housing 24, a first gear or pinion 26, a second gear having an infinite pitch radius, alternatively referred to herein as a rack 28, an arm 30, a rotatable pulley 32 and a means for applying a rotational force to the pinion 26. In an alternative embodiment, the rack and the arm may be formed as a unitary member. By applying a rotational force to the pinion 26, which is operatively engaged with the rack 28, a linear force is generated to bias the arm 30 and pulley 32 of the tensioner in a direction to tension a power transmitting element including, for example, a belt or chain.

The pinion 26 is rotatably mounted on the base 24, which may be secured to an engine or a front end accessory drive system by any conventional means including mounting bolts. A first bushing 34 may be interposed between the pinion 26 and the base 24 to provide for low friction rotation of the pinion 26 relative to the base 24. A second bushing 35 may be interposed between the pinion 26 and a top cover 80, which together with the base 24 forms a protective housing. The arm 30 is slideably mounted on the base 24 and is coupled to the rack 28 for linear movement therewith. One or more linear bushings 36 may be used to provide alignment and low friction sliding of the arm 30 relative to the base 24. The rack 28, which is coupled to the arm 30, is operatively engaged with the pinion 26 such that rotation of the pinion in a first rotational direction R1 causes linear translation of the rack 28 in a first linear direction L1. Conversely, linear translation of the rack 28 in a second linear direction L2, for example, as a result of force exerted by the belt 12, may cause the pinion 26 to rotate in a second rotational direction R2.

Engagement of the rack 28 and pinion 26 may be either direct or indirect as described in latter embodiments. The pulley 32 is rotatably mounted on the arm 30 to engage and tension the belt 12 as the arm 30 moves to take up slack. In the embodiment in which the arm 30 and rack 28 are formed as a unitary member, the pulley 32 can be said to be rotatably coupled to the rack 28 for movement therewith.

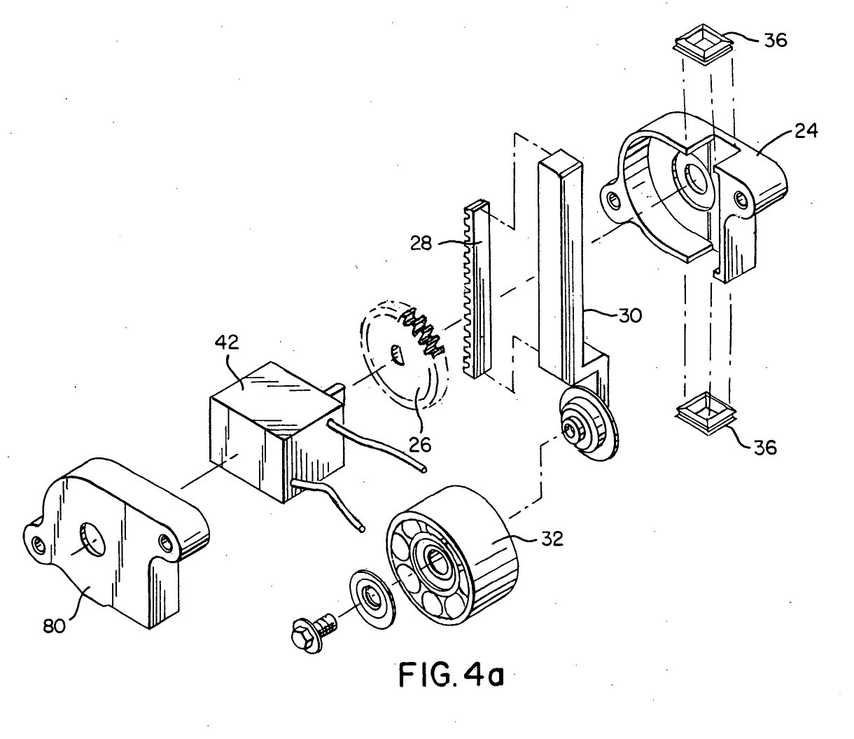

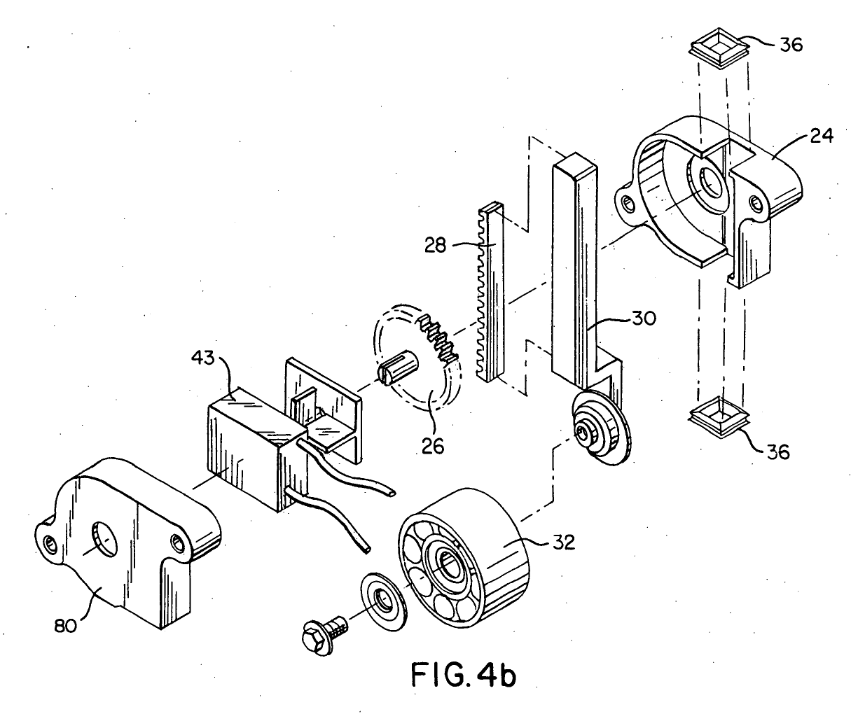

A means for applying a rotational force to the pinion 26 or for biasing the pinion to rotate in first rotational direction is provided, which may be any rotary actuator including, for example, a torsion spring 40, as in FIGS. 2 and 3, a servo motor 42, as in FIG. 4a, or a hydraulic or pneumatic pump 43, as in FIG. 4b. Of course, other devices that are known in the mechanical arts may also be used as the means to apply a rotational force to the pinion including linearly acting actuators. By exerting a linear force at a point on the pinion that is offset from the pinion's rotational axis, a moment arm is created to generate a torque. In this manner a linearly acting actuator can be employed as a rotary actuator. Suitable linearly acting actuators would include, for example, worm gears, rack and pinion assemblies, linear springs and hydraulic or pneumatic pistons.

Referring still to FIGS. 2 and 3, in the embodiment in which the means for applying a rotational force is a spring, a first or outer end 44 of the spring 40 may be engaged with or anchored to the base 24 and a second or inner end 46 of the spring 40 may be engaged with the pinion 26 such that the spring is pre-stressed. Depending on the particular application, the pulley 32 may be coupled to the arm 30 such that unwinding of the pre-stressed spring 40 either causes the arm 30 and pulley 32 to retract towards or extend from the base 24 to tension the belt 12. In other words, the tensioner 22 can operate to tension the belt 12 either by pushing or pulling the belt. In an alternative embodiment that is not shown, the inner end 46 of the spring could be coupled to a hub on the base and the outer end 44 of the spring could be coupled to the pinion 26.

Through operative engagement of the pinion 26 with the rack 28, whether direct or indirect, the rotational force exerted on the pinion 26 can be translated into a linear force to tension the belt 12. In particular, rotation of the pinion 26 in response to the applied rotational force can be translated into linear movement of the rack 28, arm 30 and pulley 32 to take up slack in the belt 12. Similarly, the means for applying a rotational force to the pinion may further operate to resist the lifting of the tensioner arm 30 by the belt 12 during transient events as in the case of a gear shift at wide open throttle.

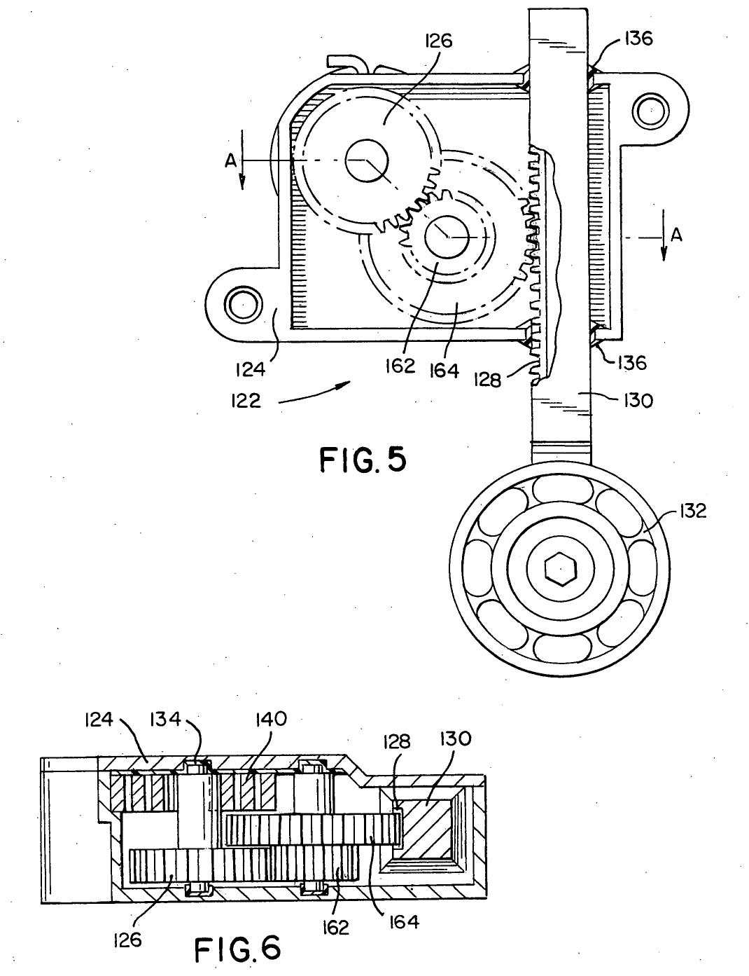

Referring to FIGS. 5 and 6, a tensioner 122 according to another embodiment is shown. As with the tensioner 22 depicted in FIGS. 2 and 3, the tensioner 122 includes a base 124, a first gear or pinion 126, a second gear or rack 128, an arm 130, a rotatable pulley 132, a first bushing 134, one or more linear bushings 136, and a means for applying a rotational force to the pinion 126, which may be for example a spring 140. In addition, the tensioner 122 according to this embodiment includes at least one intermediate gear that is operatively engaged with the rack 128 and the pinion 126. In the embodiment shown in FIGS. 5 and 6, first and second intermediate gears 162, 164 of different pitch diameters are coupled together for rotation about the same axis. The first intermediate gear 162 directly engages or meshes with the pinion 126. The second intermediate gear 164 directly engages the rack 128. The pitch diameters of the one or more intermediate gears may be selected to provide additional linear travel for the tensioner arm 130, increased torque output, or desirable tensioner spring rate.

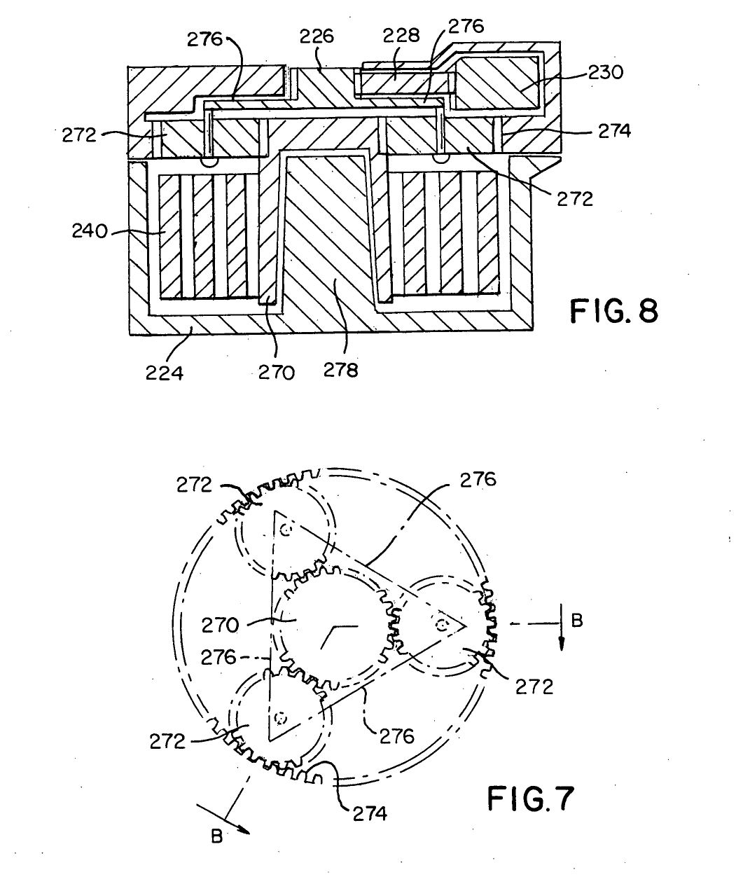

Referring to FIGS. 7 and 8, a tensioner 222 according to another embodiment is shown having a base 224, a first gear or pinion 226, a second gear or rack 228, an arm 230, a rotatable pulley identical to the previous embodiments, and a means for applying a rotational force to the pinion 226, which may be for example a spring 240. In addition, the tensioner 222 according to this embodiment also includes a planetary gear set having a sun gear 270, at least one planetary gear 272, a ring gear 274 and at least one planetary gear arm 276. The pinion 226 is operatively engaged with the spring 240 through the planetary gear set such that the spring 240 may apply a rotational force to the pinion 226.

The sun gear 270 is rotatably mounted on the base 224, for example, on a hub 278 and is urged to rotate by a means for applying a rotational force to the sun gear, which may be the spring 240. Referring to FIG. 8, an outer end of the pre-stressed spring 240 may be coupled to the base 224 while an inner end is coupled to the sun gear 270. Of course, the sun gear 270 may also be biased to rotate by other means previously described including, for example, a servo motor or hydraulic pump. A non-rotating ring gear 274 is positioned so as to be concentric with the sun gear 270 and may be formed, for example, in the interior of a cover 280 secured to the base 224. One or more planetary gears 272 are operatively engaged with both the sun gear 270 and the ring gear 274 such that rotation of the sun gear 270 causes the one or more planetary gears 272 to orbit about the sun gear 270. One or more planetary gear arms 276 couple the one or more planetary gears 272 to the pinion 226, which is concentric with the sun gear 270, such that orbital movement of the planetary gears 272 causes the pinion 226 to rotate. The pitch diameters of sun gear 270, the planetary gears 272 and the ring gear 274 may be selected to provide additional linear travel for the tensioner arm 230, increased torque output, or desirable tensioner spring rate.

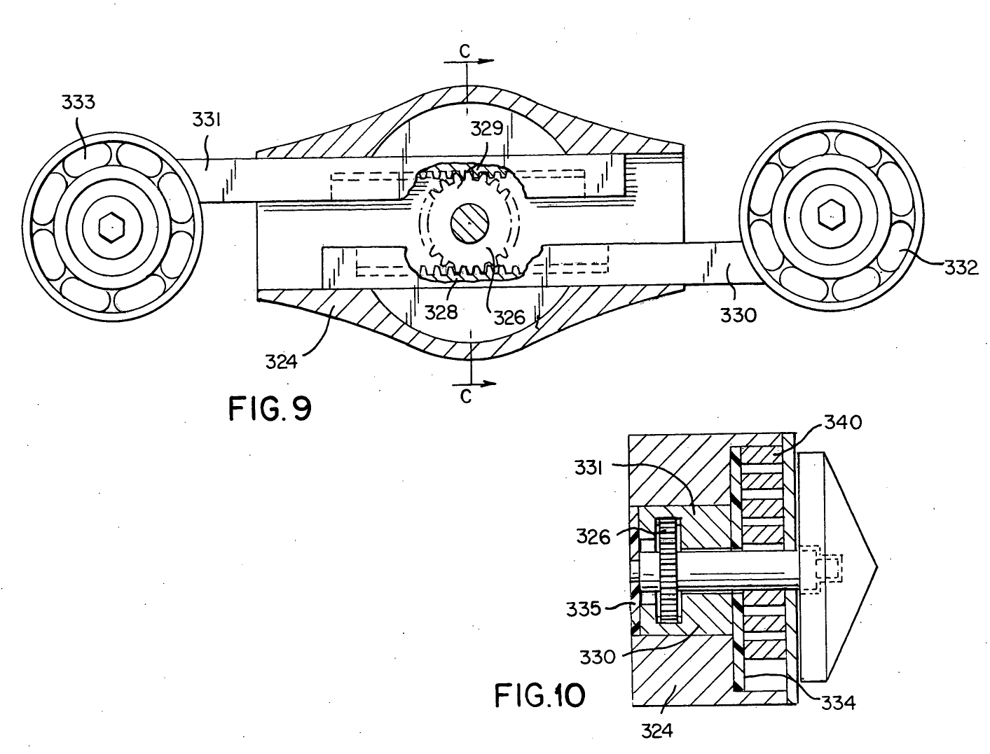

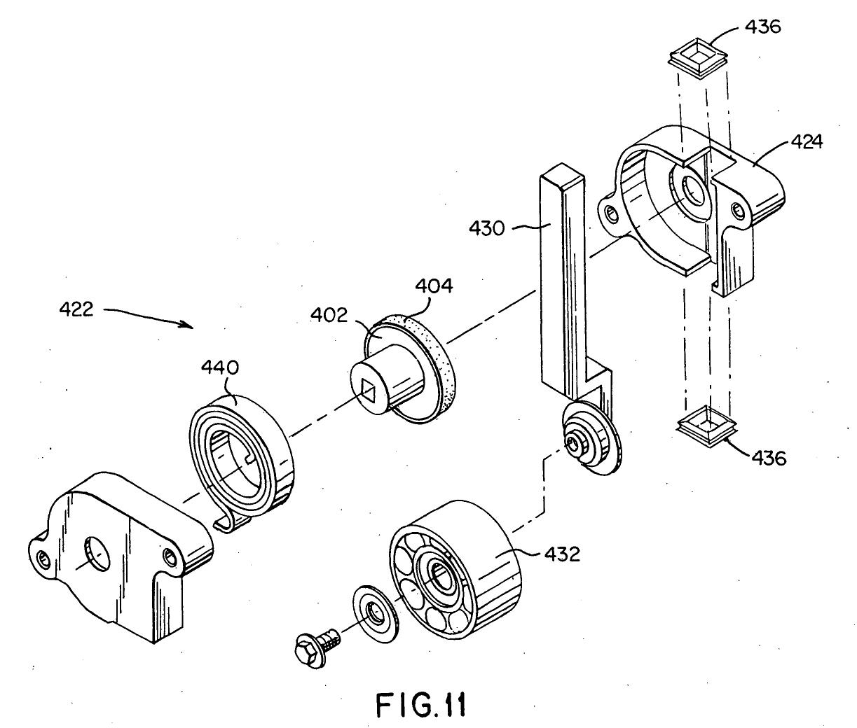

Referring to FIGS. 9 and 10, a tensioner 322 according to yet another embodiment is shown having a base 324, a pinion 326, first and second racks 328, 329, first and second arms 330, 331, first and second rotatable pulleys 332, 333, first and second bushings 334, 335, and a means for applying a rotational force to the pinion 326, which may be for example a spring 340. In this “dual-arm” embodiment the first and second racks 328, 329 are both engaged with the pinion 326 to bias the first and second arms 330, 331 and the first and second pulleys 332, 333 to simultaneously bias two spans of a power transmitting device, such as a belt. As with previous embodiments, intermediate gears or a planetary gear set could be used to provide additional linear travel for the tensioner arms 330, 331 or increase the torque output.

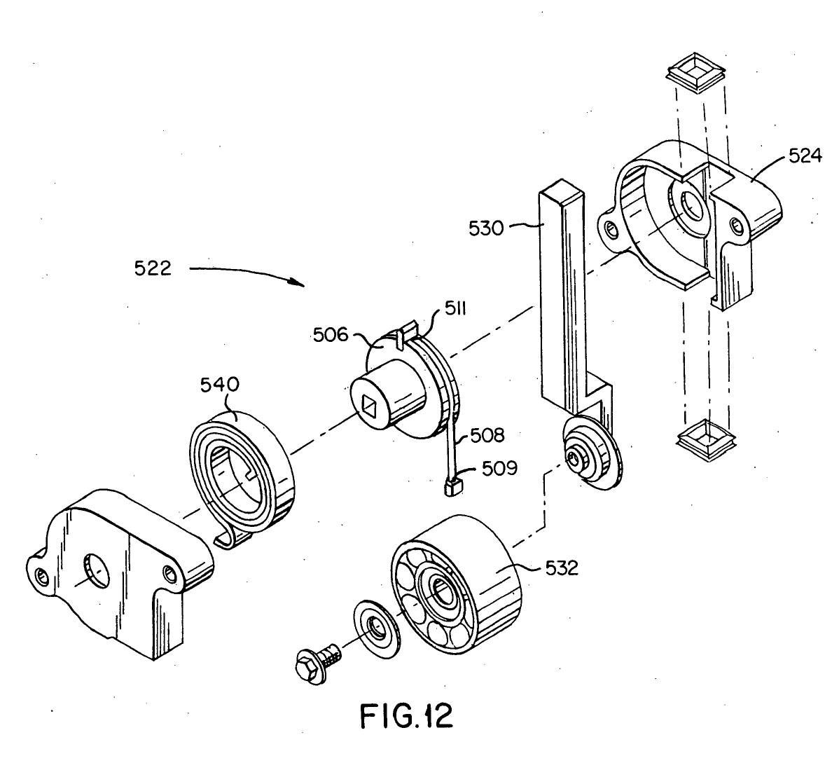

Referring to FIG. 11, a tensioner 422 according to another embodiment is shown in which the rack and pinion assembly of the previous embodiments has been replaced by a friction wheel 402. The tensioner 422 includes a base 424 on which the friction wheel 402 is rotatably mounted, an arm 430 that is operatively engaged with the friction wheel 402, a rotary actuator 440, which may be, for example, a torsion spring, and a pulley 432 rotatably coupled to the arm 430 for movement therewith. As a result of frictional engagement between an outer circumferential perimeter 404 of the friction wheel 402 and the arm 430, rotation of the friction wheel 402 in response to rotational force exerted by the rotary actuator will cause the arm 430 and pulley 432 to translate in a linear direction to tension an associated power transmitting belt. By contrast, linear motion of the arm 430 as a result of force exerted by the belt will cause the friction wheel 402 to rotate in an opposite orientation. The rotary actuator 440 may provide a force to resist this movement. As in the preceding embodiments, a second arm and pulley may be added to provide a dual arm tensioner.

Referring to FIG. 12, a tensioner 522 according to still another embodiment is shown having a base 524, a spool 506 rotatably mounted on the base 524, a rotary actuator 540, which may be, for example, a torsion spring, an arm 530 slideably mounted on the base 524, and a pulley 532 rotatably coupled to the arm 530 for movement therewith The arm 530 is operatively engaged with the spool 506 through a cable 508, which is coupled at a first end 509 to the arm 530 and coupled at a second end 511 to the spool 506 so as to be windingly engaged with the spool 506. Rotation of the spool 506 by the rotary actuator 540 is converted to linear translation of the arm 530 as the cable 508 is wound onto the spool 506. Conversely, linear translation of the arm 530 due to increasing tension in the associated power transmitting belt will cause the cable 508 to unwind from the spool 506. The rotary actuator 540 may provide resistance to unwinding of the spool 506. As with the preceding embodiments, a second arm and pulley may be added to provide a dual arm tensioner.

What is claimed is:

1. A tensioner for tensioning a power transmitting element, the tensioner comprising:
a rotatable element; and
a translating element operatively engaged with the rotatable element so that rotation of the rotatable element in a first rotational direction causes translation of the translating element in a first linear direction to tension the power transmitting element and so that translation of the translating element in a second linear direction causes rotation of the rotatable element in a second rotational direction.

2. A tensioner as claimed in claim 1, wherein the rotatable element is a pinion and the translating element is a rack.

3. A tensioner as claimed in claim 1, wherein the rotatable element is a friction wheel in frictional contact with the translating element.

4. A tensioner as claimed in claim 1, further comprising a rotary actuator for applying a rotational force to the rotatable element.

5. A tensioner as claimed in claim 1, further comprising a means for applying a rotational force to the rotatable element.

6. A tensioner as claimed in claim 5, wherein the means for applying a rotational force to the rotatable element is a torsion spring.

7. A tensioner as claimed in claim 5, wherein the means for applying a rotational force to the rotating member is a servo motor.

8. A tensioner as claimed in claim 5, wherein the means for applying a rotational force to the rotating member is a hydraulic pump.

9. A tensioner as claimed in claim 2, further comprising an intermediate gear operatively engaged with the rack and the pinion so that the pinion indirectly engages the rack through the intermediate gear.

10. A tensioner as claimed in claim 4, further comprising a pulley rotatably coupled to the translating element for movement therewith, the pulley being operable to engage and tension the associated power transmitting element.

11. A tensioner for tensioning a power transmitting element, the tensioner comprising:
a rotatable element; and
a translating element operatively engaged with the rotatable element so that rotation of the rotatable element in a first rotational direction causes translation of the translating element in a first linear direction;
wherein the translating element is capable of translating in a second linear direction opposite the first linear direction in response to force exerted by the associated power transmitting element.

12. A tensioner as claimed in claim 11, further comprising a cable having a first end coupled to the translating element and a second end coupled the rotatable element, wherein the rotatable element is a spool.

13. A tensioner as claimed in claim 11, wherein the rotatable element is a friction wheel in frictional contact with the translating element.

14. A tensioner as claimed in claim 11, wherein translation of the translating element in the second linear direction causes the rotatable element to rotate in a second rotational direction.

15. A tensioner as claimed in claim 14, wherein the rotatable element is a pinion and the translating element is a rack.

16. A tensioner as claimed in claim 11, further comprising a rotary actuator for biasing the rotatable element to rotate in the first rotational direction.

17. A tensioner as claimed in claim 11, further comprising a means for biasing the rotatable element to rotate in the first rotational direction.

18. A tensioner as claimed in claim 17, wherein the means for biasing is a torsion spring.

19. A tensioner as claimed in claim 17, wherein the means for biasing is a servo motor.

20. A tensioner as claimed in claim 17, wherein the means for biasing is a hydraulic pump.

21. A tensioner as claimed in claim 16, further comprising a pulley rotatably coupled to the translating element for movement therewith, the pulley being operable to engage and tension the associated power transmitting element.

22. A tensioner for tensioning a power transmitting element, the tensioner comprising:
a base;
a pinion rotatably mounted on the base;
a means for applying a rotational force to the pinion;
a rack operatively engaged with the pinion;
an arm slideably mounted on the base and coupled to the rack for linear movement therewith; and
a pulley rotatably mounted on the arm to engage and tension the associated power transmitting element.

23. A tensioner as claimed in claim 22, wherein the means for applying a rotational force is a torsion spring.

24. A tensioner as claimed in claim 22, wherein the means for applying a rotational force is a servo motor.

25. A tensioner as claimed in claim 22, wherein the means for applying a rotational force is a hydraulic pump.

26. A tensioner as claimed in claim 22, further comprising an intermediate gear rotatably mounted on the base and operatively engaged with both the rack and the pinion.

27. A tensioner as claimed in claim 22, further comprising:
a second rack operatively engaged with the pinion;
a second arm slideably mounted on the base and coupled to the second rack for linear movement therewith; and
a second pulley rotatably mounted on the second arm to engage and tension an associated power transmitting element.

28. A tensioner for tensioning a power transmitting element, the tensioner comprising:
a base;
a pinion rotatably mounted on the base;
a spring operatively coupled to the base and the pinion;
a rack operatively engaged with the pinion; and
a pulley rotatably mounted on the rack to engage and tension the associated power transmitting element.

29. A tensioner as claimed in claim 28, further comprising an intermediate gear rotatably mounted on the base and operatively engaged with both the rack and the pinion.

30. A tensioner as claimed in claim 28, further comprising:
a second rack operatively engaged with the pinion; and
a second pulley rotatably mounted on the second rack to engage and tension the associated power transmitting element.

31. A tensioner for tensioning a power transmitting element, the tensioner comprising:
a base;
a pinion rotatably mounted on the base;
a means for applying a rotational force to the pinion;
a rack operatively engaged with pinion such that rotation of the pinion causes linear translation of the rack;
a pulley rotatably coupled to the rack for linear movement therewith, the pulley being operable to engage and tension the associated power transmitting element; and
a planetary gear set operatively coupling the pinion and the means for applying a rotational force to the pinion.

32. A tensioner for tensioning a power transmitting element, the tensioner comprising:
a base;
a sun gear rotatably mounted on the base;
a means for applying a rotational force to the sun gear;
a ring gear concentric with the sun gear and non-rotatably mounted on the base;
a planetary gear operatively engaged with the sun gear and the ring gear such that rotation of the sun gear causes orbital movement of the planetary gear about the sun gear;
a pinion co-axially mounted with respect the sun gear for independent rotation, the pinion coupled to the planetary gear such that orbital movement of the planetary gear causes rotation of the pinion;
a rack operatively engaged with the pinion such that rotation of the pinion causes linear translation of the rack; and
a pulley rotatably coupled to the rack for linear movement therewith, the pulley being operable to engage and tension the associated power transmitting element.

33. A tensioner as claimed in claim 32, wherein the means for applying a rotational force is a torsion spring.

34. A tensioner as claimed in claim 32, wherein the means for applying a rotational force is a servo motor.

35. A tensioner as claimed in claim 32, wherein the means for applying a rotational force is a hydraulic pump.

36. A tensioner for tensioning a power transmitting element, the tensioner comprising
a base;
a friction wheel rotatably mounted on the base;
a rotary actuator for applying a rotational force to the friction wheel;
an arm slideably mounted on the base and frictionally engaged with the friction wheel; and
a pulley rotatably coupled to the arm for movement therewith, the pulley operable to engage and tension the associated power transmitting element.

37. A tensioner as claimed in claim 36, wherein the rotary actuator is a torsion spring operatively coupled at a first end to the base and at a second end to the friction wheel.

38. A tensioner for tensioning a power transmitting element, the tensioner comprising:
a base;
a spool rotatably mounted on the base;
a rotary actuator for applying a rotational force to the spool;
an arm slideably mounted on the base;
a cable coupled at a first end to the arm and coupled at a second end to the spool so as to be in winding engagement with the spool; and
a pulley rotatably coupled to the arm for movement therewith, the pulley operable to engage and tension the associated power transmitting element.

39. A tensioner for tensioning a power transmitting element, the tensioner comprising:
a rotatable element; and
a translating element operatively engaged with the rotatable element so that rotation of the rotatable element causes translation of the translating element;
wherein the tensioner is operable in a first condition and a second condition, the first condition characterized by the rotatable element rotating in a first rotational direction and the translating element translating in a first linear direction, and the second condition characterized by the translating element translating in a second linear direction opposite the first linear direction and the rotatable element rotating in a second rotational direction.

40. A tensioner as claimed in claim 39, further comprising a rotary actuator for biasing the rotatable element to rotate in the first rotational direction.

41. A tensioner as claimed in claim 40, wherein the rotary actuator resists rotation of the rotatable member in the second rotational direction.
